(19) United States
(12) Patent Application Publication
(10) Pub. No.: US 2012/0230018 A1
(43) Pub. Date: Sep. 13, 2012

(54) ILLUMINATED SHELVING

(75) Inventors: Jim Wiemer, Fox Point, WI (US); Ryan Brobst, Grafton, WI (US); Jan Pergande, Cedarburg, WI (US)

(73) Assignee: DCI Marketing, Inc. (a Wisconsin corporation), Milwaukee, WI (US)

(21) Appl. No.: 13/415,138

(22) Filed: Mar. 8, 2012

Related U.S. Application Data
(60) Provisional application No. 61/450,420, filed on Mar. 8, 2011.

(51) Int. Cl. F21V 33/00

(52) U.S. Cl. 362/133

(57) ABSTRACT

An illuminated shelving system is provided having light bars attached to the shelves. The light bars are electrically connected to a power strip that conducts electricity from a wall outlet to a plurality of light bars.

### CROSS-REFERENCE TO RELATED APPLICATION

This application is based on and claims priority to U.S. Provisional Patent Application No. 61/450,420 filed on Mar. 8, 2011, which is incorporated herein by reference in its entirety for all purposes.

### FIELD OF THE INVENTION

The present invention relates generally to the field of display shelving. More particularly, the present invention relates to a shelving system that incorporates low voltage light fixtures attached to one or more shelves.

### BACKGROUND

In the retail environment, it is common for merchandise to be displayed on a series of adjustable shelves. Retail display shelving falls into two basic categories: (1) cases where shelves are supported by pins inserted into holes on each side of the case or (2) wall displays where a number of vertically oriented, slotted standards are attached to a wall and brackets having hooks designed to engage the slots support the shelves.

It is desirable to present the merchandise displayed on the shelves in a way that is attractive and easily visible to a potential customer. One way to increase the visibility of merchandise is to provide adequate lighting. In many retail environments, the primary source of lighting is provided by ceiling mounted fixtures. Specific products may also be highlighted or accented through the use of spot lights. When non-illuminated shelving is used, the upper shelves cast shadows that result in less than optimal lighting for the lower shelves.

There have been previous attempts to create shelving systems with integrated lighting, but those solutions present a number of shortcomings that the present invention seeks to address. Many such shelving systems essentially mounted existing light fixtures to the bottoms of already existing shelves. Such a solution presented the problem that each light fixture had a conventional plug that needed to be plugged into an outlet. For a system with fixed shelves, or shelves with a limited range of adjustment, the power cords could be relatively easily hidden. If the shelving has a broader range of adjustment, it is necessary to provide excess power cord, which is more difficult to hide.

As such, there is a need for a retail shelving system that incorporates lighting into the shelves such that the shelves may be quickly, easily, and safely reconfigured.

### SUMMARY OF THE INVENTION

The present invention relates to an illuminated shelving system with integrated lighting for displaying items. The illuminated shelving system includes at least one shelf that is removably attached to a shelf support that supports the shelf in a horizontal position. The shelf support further includes a power strip to which the plug is removably attached and which provides electrical power to the light bar. At least one light bar is attached to at least one of the shelves and includes a power cable. An electrical plug is attached to the free end of the power cable. Each shelf includes a channel that encloses the power cable.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a front perspective view of one embodiment of an illuminated shelving system in accordance with the invention;

FIG. 2 is a perspective view of the illumination components of the shelving system of FIG. 1;

FIG. 3 is a perspective view of another embodiment of an illuminated shelving system in accordance with the invention;

FIG. 4 is a perspective view of a shelf of the shelving system of FIG. 3;

FIG. 5 is a detail perspective view of the shelf of FIG. 4, showing the underside detail of the shelf; and

FIG. 6 is a section view of a lamp bracket in accordance with the shelving system of FIG. 3, taken generally along the line 6-6 in FIG. 4.

### DETAILED DESCRIPTION

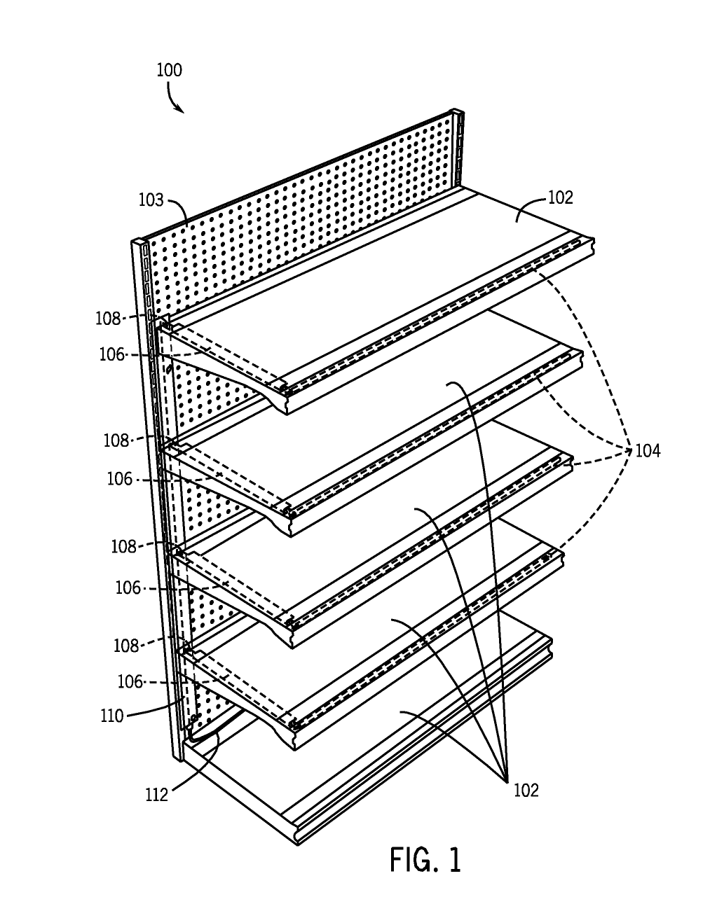

FIG. 1 is a perspective view of one embodiment of an illuminated shelving system in accordance with the invention. The shelving system 100 includes shelves 102 attached to a shelf support 103, light strips 104, light strip power cords 105, cord channels 106, and plugs 108 that connect to a power strip 110 that, in turn, is connected to a power source by a power cord 112. As shown, the shelves 102 are removably attached to the shelf support 103 and may be adjusted as required by the retailer to provide the proper spacing for displaying products. The light strips 104 are array of light emitting diodes (LED), but other lighting technologies such as halogen, fluorescent, or incandescent lamps may also be used without departing from the present invention. The light strips 104 may provide continuous brightness across the light strip, or may be configured to illuminate only certain portions of the shelf. Such a configuration allows the light strips 104 to provide accent lighting if so desired.

The light strips 104 are removably attached to the bottom surface of as many of the shelves 102 as is desired. The light strips 104 may be attached to the shelf 102 by adhesive, hook and loop fastener, bracket, or other attachment means. Each light strip 104 may be removably attached to the power strip 110.

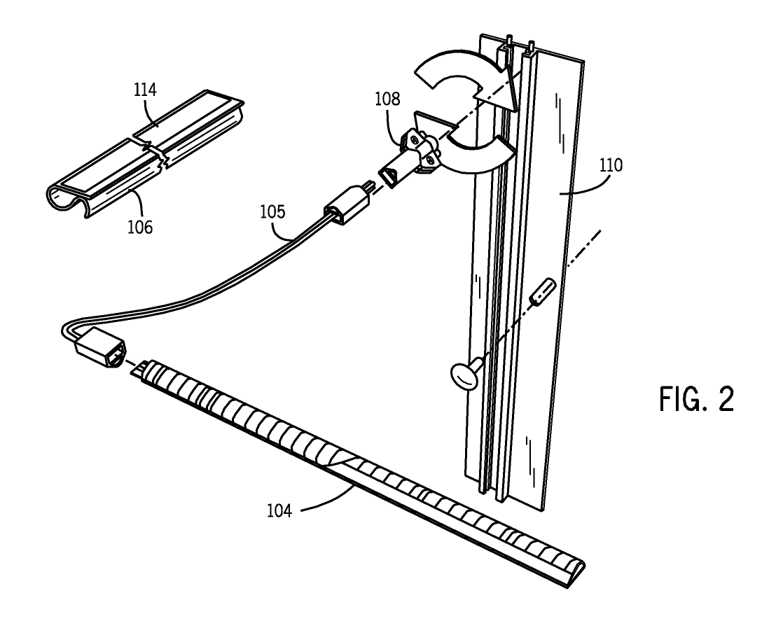

FIG. 2 is another perspective view of the illuminated shelving system of FIG. 1. FIG. 2 shows in greater detail how the lighting components themselves are interconnected. A light strip 104 is connected to a power strip 110 by a light strip power cord 105 and a plug 108. As shown, the shelving system 100 includes a low voltage lighting system incorporating Light Emitting Diode (“LED”) lighting elements, including the power strip 110, which is a low voltage power strip such that individual plugs are not necessary. Of course, other power strips may be used without departing from the invention. The power cord 105 and plug 108 may be separate components as shown in FIG. 2, or may be created as a single component.

As shown, the power strip 110 is a continuous channel that provides much greater flexibility in terms of where the plug 108 is connected to the power strip 110 than a conventional electrical socket. Such flexibility allows the retailer to position the shelves 102 as desired without concern for where the plug 108 nay be connected to the power strip 110. The plug 108 shown in the present embodiment is a “Twist and Lock” type, but other types may be used without departing from the invention. A cable channel 106 that guides the light strip power cord 105 from the light strip 104 to the power strip 110 is attached to the underside of each shelf 102 by double sided tape 114. Other fastening means may also be used without departing from the invention.

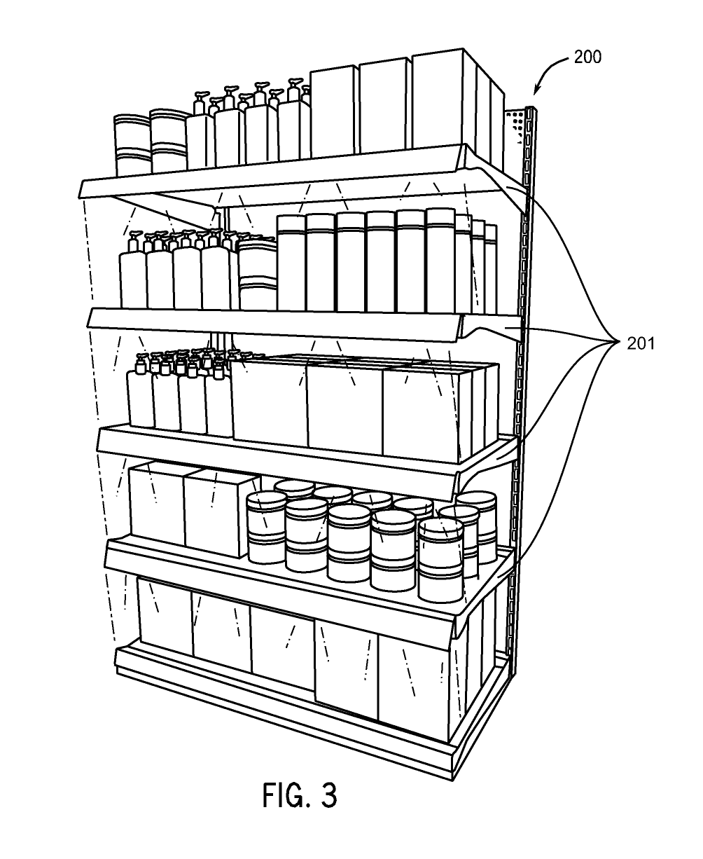

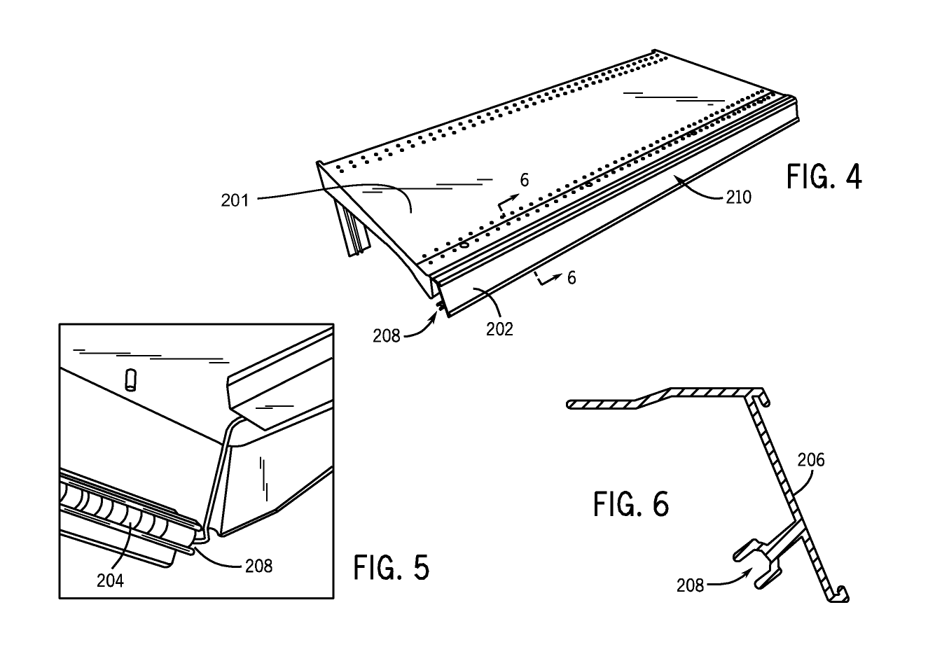

FIGS. 3-6 are perspective views of another embodiment of an illuminated shelving system 200 in accordance with the invention. Electrically, the embodiment illustrated in FIGS. 1-2 and the present embodiment are identical. Rather than attaching the light bar 104 directly to the underside of each shelf 102, however, the embodiment illustrated in FIGS. 3-6 includes a bracket 202 that is attached to the front edge of an existing shelf 201. The bracket 202 includes mounts 208 for attaching the light strip 204, which is electrically attached to a power strip 210. The bracket 202 may be made of extruded plastic that allows some of the light to illuminate price labels attached to the front of the bracket 206.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An illuminated shelving system comprising:
at least one shelf having top and bottom surfaces and removably attached to a shelf support that supports the shelf in a horizontal position;
at least one light bar removably attached to the shelf and including a first and second end;
a power cable connected to the first end of the light bar and further including an electrical plug;
a channel attached to the shelf and enclosing the power cable;
a power strip attached to the shelf support; and
the plug removably attached to the power strip.

2. The illuminated shelving system of claim 1 wherein the at least one light bar is attached to the bottom surface of the shelf.

3. The illuminated shelving system of claim 1 wherein the at least one light bar is made of light emitting diodes.

4. The illuminated shelving system of claim 1 wherein the at least one light bar is a fluorescent tube.

5. The illuminated shelving system of claim 1 wherein the electrical plug is a low voltage twist and lock type.

6. An illuminated shelving system comprising:
at least one shelf having top and bottom surfaces and removably attached to a shelf support that supports the shelf in a horizontal position;
a light bar support bracket removably attached to the at least one shelf;
a light bar removably attached to the light bar support bracket and including a first and second end;
a power cable connected to the first end of the light bar and further including an electrical plug;
a channel attached to the shelf and enclosing the power cable;
a power strip attached to the shelf support; and
the plug removably attached to the power strip.

7. The illuminated shelving system of claim 6 wherein the at least one light bar is made of light emitting diodes.

8. The illuminated shelving system of claim 6 wherein the at least one light bar is a fluorescent tube.

9. The illuminated shelving system of claim 6 wherein the electrical plug is a low voltage twist and lock type.

10. An illuminated shelving system comprising:
at least one shelf having top and bottom surfaces and removably attached to a shelf support that supports the shelf in a horizontal position;
at least one light bar removably attached to the bottom surface of the shelf and including a first and second end;
a power cable connected to the first end of the light bar and further including an electrical plug;
a channel attached to the shelf and enclosing the power cable;
a power strip attached to the shelf support; and
the plug removably attached to the power strip.
